(19) United States
(12) Patent Application Publication
(10) Pub. No.: US 2015/0205543 A1
(43) Pub. Date: Jul. 23, 2015

(54) STORAGE DEVICE AND DATA STORING METHOD

(71) Applicant: Kabushiki Kaisha Toshiba, Minato-ku (JP)

(72) Inventors: Fumitoshi HIDAKA, Yokohama-shi (JP); Masatoshi Aoki, Yokohama-shi (JP); Itaru Kakiki, Yokohama-shi (JP); Kaori Nakao, Tokyo (JP)

(73) Assignee: Kabushiki Kaisha Toshiba, Minato-ku (JP)

(21) Appl. No.: 14/263,018

(22) Filed: Apr. 28, 2014

(30) Foreign Application Priority Data
Jan. 17, 2014 (JP) 2014-007090

(51) Int. Cl. G06F 3/06; G06F 12/02

(52) U.S. Cl. CPC G06F 3/0685; G06F 12/0246; G06F 3/0604; G06F 3/0658; G06F 2003/0697; G06F 2212/7207

(57) ABSTRACT

According to one embodiment, a storage device includes a first nonvolatile storing unit having a predefined first management area, and a second nonvolatile storing unit configured to process data at a higher rate than the first nonvolatile storing unit. The first nonvolatile storing unit stores, in the first management area, first management information associated with the first nonvolatile storing unit, and second management information associated with the second nonvolatile storing unit.

### CROSS-REFERENCE TO RELATED APPLICATIONS

This application is based upon and claims the benefit of priority from Japanese Patent Application No. 2014-007090, filed Jan. 17, 2014, the entire contents of which are incorporated herein by reference.

### FIELD

Embodiments described herein relate generally to a storage device and a data storing method.

### BACKGROUND

Storage devices each provided with a plurality of (e.g., two) nonvolatile storage media with different access rates and memory capacities have recently been developed. As a typical storage device, a hybrid drive is known. In general, the hybrid drive comprises a first nonvolatile storage medium, and a second nonvolatile storage medium having a lower access rate and a higher memory capacity than the first nonvolatile storage medium.

As the first nonvolatile storage medium, a semiconductor memory, such as a NAND flash memory, is used. The NAND flash memory is known as a nonvolatile storage medium capable of being accessed at high rate although its per-unit-capacity price is high. As the second nonvolatile storage medium, a disk medium, such as a magnetic disk, is used. The disk medium is known as a nonvolatile storage medium of a low per-unit-capacity price although its access rate is low. In view of the above, the hybrid drive may use the disk medium (more specifically, a disk drive including the disk medium) as main storage, and uses the NAND flash memory (more specifically, a NAND flash memory of a higher access rate than the disk medium) as a cache. Even when the NAND flash memory is used as a cache, a management area (system area) for storing data to be stored in the NAND flash memory and data indicating the characteristic of the NAND flash memory is needed.

### BRIEF DESCRIPTION OF THE DRAWINGS

FIG. 1 is a block diagram showing the typical structure of a hybrid drive according to an embodiment;

FIG. 2 shows a typical format for the memory area of a NAND memory shown in FIG. 1;

FIG. 3 is a flowchart showing a procedure, according to the embodiment, of writing HDD management information and NAND management information; and

FIG. 4 is a flowchart of processing executed after a power signal is input.

### DETAILED DESCRIPTION

In general, according to one embodiment, a storage device includes a first nonvolatile storing unit having a pre-defined first management area, and a second nonvolatile storing unit configured to process data at a higher rate than the first nonvolatile storing unit. The first nonvolatile storing unit stores, in the first management area, first management information associated with the first nonvolatile storing unit, and second management information associated with the second nonvolatile storing unit.

The embodiment will be described with reference to the accompanying drawings.

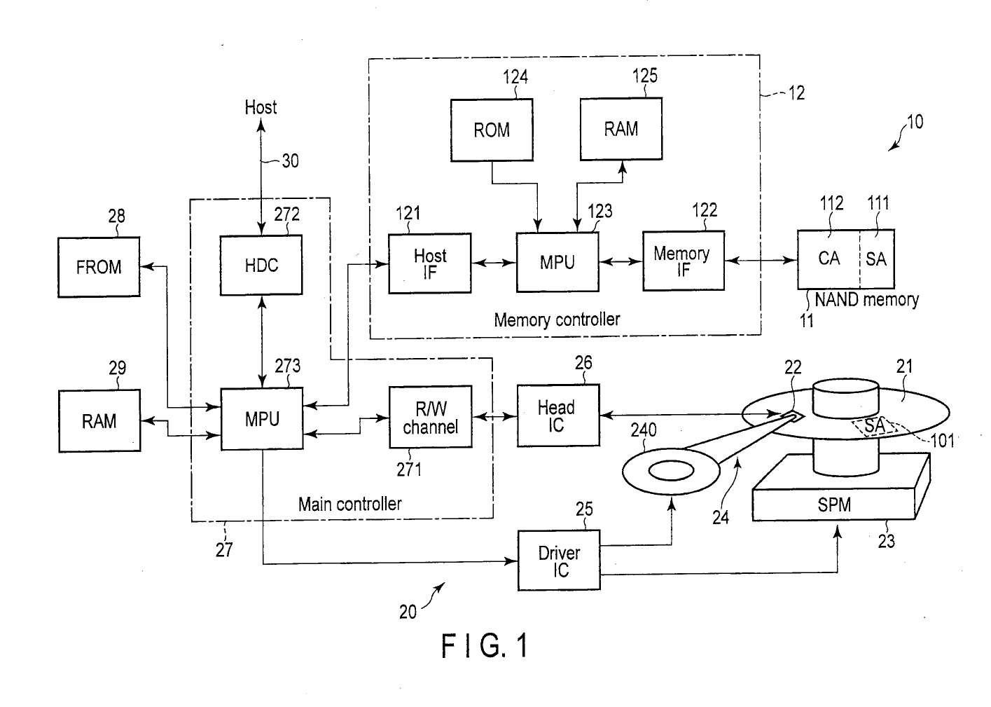

FIG. 1 is a block diagram showing the typical structure of a hybrid drive according to the embodiment. The hybrid drive is provided with a plurality of, e.g., two, storage media (i.e., a first nonvolatile storage medium and a second nonvolatile storage medium) having different access rates and memory capacities. In the embodiment, a NAND flash memory (hereinafter, a NAND memory) 11 is used as the first nonvolatile storage medium, and a magnetic disk medium (hereinafter, a disk) 21 is used as the second nonvolatile storage medium. As will be described later, the disk 21 has a system area (SA) 101 for storing management information. The access rate and memory capacity of the disk 21 are lower and greater than those of the NAND memory 11.

The hybrid drive shown in FIG. 1 comprises a semiconductor drive unit 10, such as a solid state drive, and a hard disk drive unit (hereinafter, an HDD) 20. The semiconductor drive unit 10 includes a NAND memory 11 and a memory controller 12. In the hybrid drive, the NAND memory 11 is used for various purposes. The NAND memory 11 is used for, for example, enhancement of performance of the hybrid drive, stabilization of a writing operation when the hybrid drive is vibrating, and enhancement of the activation rate of the hybrid drive. As will be described later, the NAND memory 11 has a system area (SA) 111 for recording management information.

The memory controller 12 controls access to the NAND memory 11 in accordance with an access request (e.g., a write or read request) from a main controller 27. In the embodiment, the NAND memory 11 is used as a cache (cache memory) for storing the data recently accessed by a host apparatus (hereinafter, a host), in order to increase the rate of access to the hybrid drive by the host. The host utilizes the hybrid drive shown in FIG. 1 as its own storage.

The memory controller 12 includes a host interface controller (hereinafter, a host IF) 121, a memory interface controller (hereinafter, a memory IF) 122, a microprocessor unit (MPU) 123, a read only memory (ROM) 124 and a random access memory (RAM) 125. The host IF (first interface controller) 121 is connected to the main controller 27. The host IF 121 receives a signal from the main controller 27 (more specifically, an MPU 273 incorporated in the main controller 27 and described later), and transmits a signal to the main controller 27. More specifically, the host IF 121 receives a command (write and read commands, etc.) from the main controller 27 and transfers it to the MPU 123. Further, the host IF 121 returns, to the main controller 27, a response from the MPU 123 in response to the command from the main controller 27. Namely, the host IF 121 controls data transfer between the main controller 27 and the MPU 123. The memory IF (second interface controller) 122 is connected to the NAND memory 11 and access the NAND memory 11 under the control of the MPU 123.

The MPU 123 executes processing (e.g., write or read processing) for accessing the NAND memory 11, in accordance with a first control program based on a command from the main controller 27. In the embodiment, the first control program is beforehand stored in the ROM 124. Instead of the ROM 124, a rewritable nonvolatile ROM, such as a flash ROM, may be used. A part of the memory area of the RAM 125 is used as a work area for the MPU 123. Another part of the memory area of the RAM 125 is used to store an access counter table 125a, which will be described later.

The HDD 20 includes a disk 21, a head 22, a spindle motor (SPM) 23, an actuator 24, a driver integrated circuit (IC) 25, a head IC 26, the above-mentioned main controller 27, a flash ROM (FROM) 28 and a RAM 29. The disk 21 comprises one surface used as a recording surface on which data is magnetically recorded. A part of the recording surface is used as the system area (SA) 101. The disk 21 is rotated at high rate by the SPM 23. The SPM 23 is driven by a driving current (or driving voltage) supplied from the driver IC 25.

The HDD 20 shown in FIG. 1 includes a single disk 21. Alternatively, the HDD may include a plurality of disks 21. Further, in FIG. 1, the disk 21 comprises one recording surface. However, the disk 21 may comprise two opposite recording surfaces, and include two heads corresponding to the recording surfaces.

The disk 21 (more specifically, the recording surface of the disk 21) comprises a plurality of tracks arranged, for example, concentrically. Alternatively, the disk 21 may have a plurality of tracks providing a spiral form. A part of the recording surface of the disk 21 beforehand includes a management (system) area 101. The system area 101 may also be referred to as an HDD SA 101. The system area 101 holds (stores) management information (HDD management information) associated with the HDD 20, and the same information as management information (NAND management information) associated with the NAND memory 11 described later.

The head (head slider) 22 is aligned with the recording surface of the disk 21. The head 22 is attached to the tip of a suspension extended from the arm of the actuator 24. The actuator 24 comprises a voice coil motor (VCM) 240 as a drive source for driving the actuator 24. The VCM 240 is powered by a driving current supplied from the driver IC 25. When the actuator 24 is driven by the VCM 240, the head 22 radially moves over the disk 21 to describe an arc.

The driver IC 25 drives the SPM 23 and the VCM 240 under the control of the main controller 27 (more specifically, the MPU 273 in the main controller 27). By driving the VCM 240 using the driver IC 25, the head 22 is positioned on a target track on the disk 21.

The head IC 26 is also called a head amplifier. The head IC 26 is secured to, for example, a predetermined portion of the actuator 24, and is electrically connected to the main controller 27 via a flexible printed circuit board (FPC). In FIG. 1, however, the head IC 26 is placed away from the actuator 24 for facilitating the drawing of the figure.

The head IC 26 amplifies the signal (i.e., the read signal) indicating the data read by the read element of the head 22. Further, the head IC 26 converts, into a write current, the write data output from the controller 27 (more specifically, an R/W channel 271 incorporated in the main controller 27), and outputs the write current to the write element of the head 22.

The main controller 27 is realized by, for example, a large-scale integrated circuit (LSI) comprising a plurality of elements integrated in one chip. The main control 27 includes the read/write (R/W) channel 271, a hard disk controller (HDC) 272 and the MPU 273.

The R/W channel 271 processes signals associated with read/write. Namely, the R/W channel 271 converts, into digital data, the read signal amplified by the head IC 26, and decodes read data from the digital data. Further, the R/W channel 271 encodes the write data transferred from the HDC 272 via the MPU 273, and transfers the encoded write data to the head IC 26.

The HDC 272 is connected to the host via a host interface (storage interface) 30. The host and the hybrid drive shown in FIG. 1 are incorporated in an electronic device, such as a personal computer, a video camera, a music player, a mobile terminal, a mobile phone or a printer.

The HDC 272 functions as a host interface controller for receiving a signal from the host and transferring a signal to the host. More specifically, the HDC 272 receives a command (a write command, a read command, etc.) from the host, and transfers the command to the MPU 273. Further, the HDC 272 controls data transfer between itself and the host. The HDC 272 also functions as a disk interface controller for controlling writing of data to the disk 21 and reading of data from the disk 21 via the MPU 273, the R/W channel 271, the head IC 26 and the head 22.

The MPU 273 controls access to the NAND memory 11 via the memory controller 12 and access to the disk 21 via the R/W channel 271, the head IC 26 and the head 22, in response to an access request (a write request or a read request) from the host. This control is executed in accordance with a second control program. In the embodiment, the second control program is stored in the FROM 28. A part of the memory area of the RAM 29 is used as a work area for the MPU 273.

An initial program loader (IPL) may be installed in the FROM 28, and the second control program be installed in the disk 21. In this case, it is sufficient if the MPU 273 executes the IPL to load the second control program from the disk 21 to the FROM 28 or the RAM 29 upon power-on of the hybrid drive.

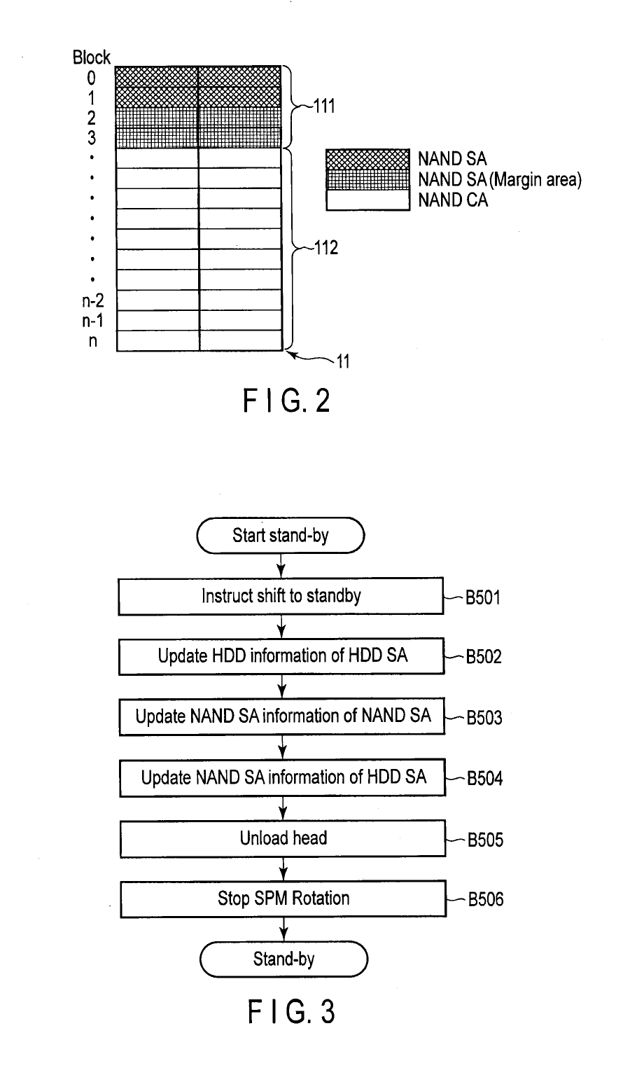

FIG. 2 shows a typical format for the memory area of the NAND memory 11. In FIG. 2, the memory area of the NAND memory 11 is formed of N blocks (physical blocks). In the NAND memory 11, data is erased on a block basis. Namely, each block is a unit of data erasure. As shown in FIGS. 1 and 2, the memory area of the NAND memory 11 is divided into the system area (SA) 111 and a cache area (CA) 112. Thus, the NAND memory 11 comprises the system area 111 and the cache area 112. In general, the system area 111 is sufficiently smaller than the cache area 112. The system area 111 of the NAND memory 11 may also be referred to as a NAND SA 111, and the cache area 112 of the NAND memory 11 also be referred to as a NAND CA 112.

The system area 111 is used to store information (NAND management information) for enabling the system (e.g., the memory controller 12) to manage reading, writing and erasing of data from, to and from the NAND memory 11. Thus, the NAND management information for the NAND memory 11 is stored in the system area 111. Since it is preferable to store the NAND management information in a redundant manner (multiplexed manner), backup data of the NAND management information may be stored in the system area 111. The cache area 112 is used to store the data recently accessed by the host.

The NAND management information includes information associated with the basic structure of the NAND memory 11, the number of command executions, the version information of the controller of the NAND memory 11, the number of times of data rewriting to the NAND memory 11, etc.

In the memory area of the NAND memory 11, the minimum unit for writing differs from that for erasure, and hence rewriting of only part of the data is impossible. For instance, in the NAND memory 11, the minimum unit for writing is one page, and the minimum unit for erasure is one block. One block includes 64 pages. As mentioned above, an erasure operation in the memory area of the NAND memory 11 is performed on a block basis that includes a plurality of pages.

Further, rewriting (overwriting) operation is not completed by one operation. Data writing is performed after data erasure. Namely, to rewrite even one page, it is necessary to erase the entire one block, and therefore the data of the one block is temporarily stored in another memory area.

The NAND management information stored in the system area 111 is referred to for confirmation upon the activation (power-on) of the hybrid drive. If no NAND management information can be obtained, it is determined that all data in the NAND memory 11 has been lost. As one of the factors of the fact that the NAND management information cannot be confirmed, degradation of the memory area (in particular, the system area 111) of the NAND memory 11 is considered. In the hybrid drive, degradation of the system area of the NAND memory can be controlled to some extent by installing a plurality of nonvolatile storage media. In this case, however, unless a sufficient number of NAND memories are installed, multiplication cannot be realized in a sufficient number of system areas. As a result, degradation of the system areas cannot sufficiently be suppressed. In such a hybrid drive, NAND management information may become unable to obtain because of degradation of the system area. Unless the NAND management information is obtained, the reliability of the entire hybrid drive will be reduced.

For instance, as a degradation countermeasure for the memory area of the NAND memory 11, an appropriate margin area corresponding to a required amount of NAND management information is provided in the system area 111 as shown in FIG. 2. The NAND management information may be stored also in the margin area of the system area 111. As a result, concentration of use of a particular portion of the system area 111 is avoided, thereby smoothing writing to the system area 111 and suppressing the degradation of the particular portion. Further, as another degradation countermeasure for the system area 111, a plurality of NAND memories 11 having respective system areas 111 are provided to multiplex record data. When multiplexing record data, a sufficient number of NAND memories 11 are employed.

The system area 111 is used to store a cache management table (logic physics conversion table), a first free-area list, a second free-area list and a bad block list. In the description below, the logic physics conversion table may be referred to simply as a table. Further, the first and second free-area lists and the bad block list may be referred to simply as lists.

As described above, in the NAND memory 11, new data (updated data) cannot be overwritten on the area that already stores data. Accordingly, the table stored position in the system area 111 may be changed whenever the table is updated. In this case, the updated table (new table) may be stored in an area different from the area that stores the table (old table) before updating. The same can be said of the storing positions of the lists in the system area 111.

Assume that the information concerning the storing positions and sizes of the table, the lists, etc. is stored as NAND management information in parts of the work area of the RAM 125, HDD SA 101 and NAND SA 111. In the embodiment, the information stored in the HDD SA 101 or the NAND SA 111 is read upon the activation of the hybrid drive under the control of the MPU 273, and is loaded to the work area of the RAM 125 via the host IF 121 and the MPU 123. If the storage positions of the table and the lists in the system area 111 have been changed, the MPUs 123 and 273 update the corresponding position information stored in the part of the work area of the RAM 125, and the corresponding position information stored in the parts of the HDD SA 101 and the NAND SA 111.

The logic physics conversion table is used to store block management information for managing each block in the cache area 112 of the NAND memory 11. In the embodiment, the block management information is used as cache directory information associated with addresses assigned to the respective data items stored in blocks (=areas of a predetermined size) included in the cache area 112. The cache directory information includes information for managing the correspondence between the physical address of each data item and the logical address of each block data item. The physical address (in this embodiment, a physical block number) assigned to each block data item indicates the position of the block (area) of the NAND memory 11 that stores said each block data item. The logical address (=logical block number) assigned to each block data item indicates the position of said each block data item in a logical address space. In general, in the NAND memory, if neither of the aforementioned NAND management information and the logic physics conversion table can be read, preparation of activation is not completed, as will be described later.

The first free-area list is used to register a first type of free area in the cache area 112. Namely, the first free-area list is used as first information for managing the first type of free area. The first type free area means a normal free area. The second free-area list is used to register a second type of free area in the cache area 112. Namely, the second free-area list is used as second information for managing the second type of free area. The second type free area means a free area in which a read error occurred in the past. The bad block list is used to register a block (physical block) determined to be unusable. Namely, the bad block list is used to register a bad block (area). The bad block list is used as third information for managing the bad block.

Assume that each block in the cache area 112 is formed of a plurality of pages (physical pages). In this case, each logical block is formed of a plurality of pages (logical pages).

The logical page number indicates a logical page (a logical page in a logical block) to which a page (physical page) of the corresponding physical block number and the physical page number is assigned. Namely, the logical page number indicates the position, in the logical address space, of the data of the corresponding physical page.

Referring now to FIG. 3, a description will be given of the processing of the hybrid drive of the embodiment shown in FIG. 1. FIG. 3 is a flowchart showing a procedure of writing HDD management information and NAND management information, executed when the hybrid drive has received, from the host, a command for shifting to a standby state or a power-off state.

In the embodiment, when the NAND SA 111 is updated, the NAND management information stored in the NAND SA 111 is recorded in the HDD SA 101 beforehand defined in the HDD. The NAND SA 111 is updated, for example, when the hybrid drive shifts to a standby state upon receiving a power-off signal, when the hybrid drive shifts to a power save mode, and when user data (cache data) in the NAND CA 112 is flashed onto the disk 21. In the flowchart of FIG. 3, the case where the hybrid drive shifts to the standby state upon receiving the power-off signal is supposed. In the embodiment, the HDD SA 101 is beforehand defined on the recording surface 21 of the disk 21.

When having received a power-off signal from the host (e.g., received a command to shift to the standby state), the main controller 27 instructs the MPU 123 via the host IF 21 to shift to the standby state (B501). In response to this instruction, the VCM 240 is driven by the driver IC 25 to position the head 22 on the predetermined HDD SA 101 of the disk 21. At this time, the HDD management information of the HDD SA 101 is updated (B502). Further, under the control of the MPU 123 corresponding to the instruction to the MPU 273, the NAND management information of the NAND SA 111 is updated (B503). The MPU 123 transfers, to the main controller 27 via the host IF 121, the same information (write data) as the updated NAND management information of the NAND SA 111. The transferred write data is further transferred to the R/W channel 271 via the MPU 273 of the main controller 27. The R/W channel 271 encodes the write data and transfers the encoded write data to the head IC 26. The head IC 26 outputs the write data to the write element of the head 22. At this time, the head 22 is positioned to the recording position of the predefined HDD SA 101 by the VCM 240 driven under the control of the main controller 27. As a result, the write data is written to the predefined HDD SA 101 (S504).

Subsequently, under the control of the main controller 27, the driver IC 25 drives the VCM 240 to move the head 22 from the recording surface of the disk 21 to the outside of the disk 21 (B505), and then stops the SPM 23 (B506). After that, the hybrid drive shifts to the standby state, whereby it is powered off. By the above-described procedure, the NAND management information stored in the NAND SA 111 is stored in the HDD SA 101.

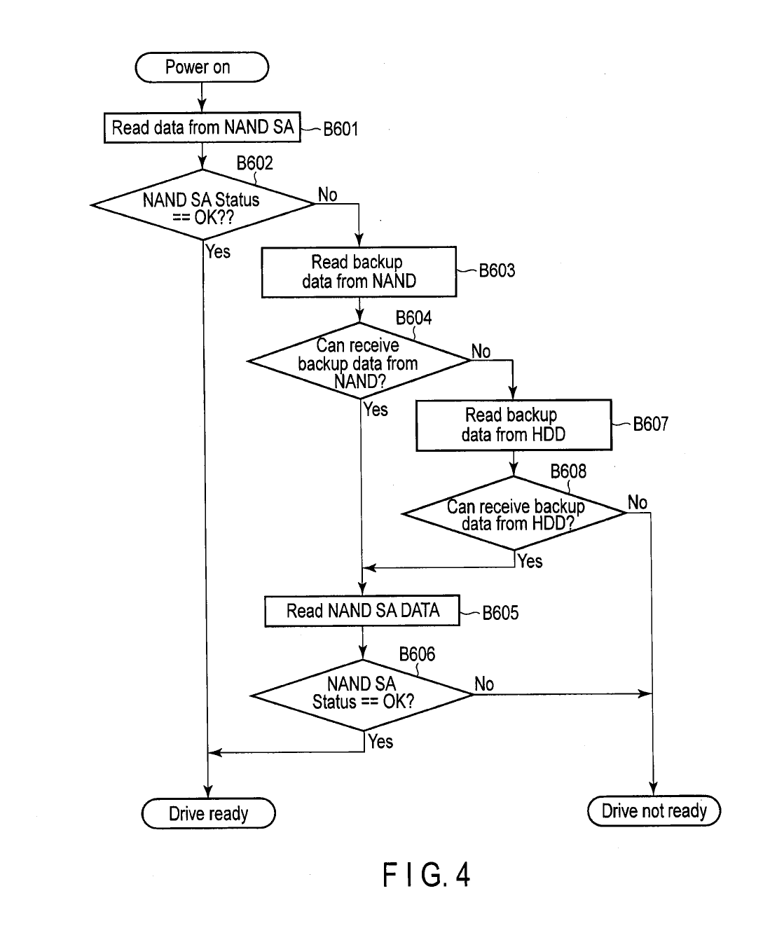

Referring then to FIG. 4, a description will be given of processing, executed by the hybrid drive of the embodiment, of reading the above-mentioned updated NAND management information. FIG. 4 is a flowchart of processing executed after a power signal is input to the hybrid drive. In FIG. 4, it is assumed that the HDD SA 101 of the disk 21 stores NAND management information.

When a power-on signal has been received from the host, the MPU 123 attempts to read the NAND management information from the NAND SA 111 (B601), thereby detecting the state of the NAND SA 111 (B602). If it is determined that the NAND SA 111 is in a normal state (Yes in B602), the activation preparation of the hybrid drive is completed, and the hybrid drive operates normally.

If it is determined in B602 that the NAND SA 111 is in an abnormal state (if, for example, a defective block has been detected) (No in B602), the MPU 23 attempts to read backup data of the NAND management information from the NAND SA 111 (B603), thereby confirming whether the backup data can be obtained (received) (B604). If it is determined that the backup data can be obtained (Yes in B604), the MPU 23 reads in the backup data of the NAND management information (B605). After that, the state of the NAND SA 111 is again checked (B606). If the state of the NAND SA 111 is determined normal (Yes in B606), the activation preparation of the hybrid drive is completed, and the hybrid drive operates normally. In contrast, if it is determined in B606 that the state of the NAND SA 111 is abnormal (No in B606), the activation preparation of the hybrid drive is not completed.

If it is determined in B604 that no backup data can be obtained (No in B604), the MPU 23 attempts to read the backup data of the NAND management information from the HDD SA 101 (B607), thereby detecting whether the backup data can be obtained (received) from the HDD SA101 (B608). If it is determined that the backup data can be obtained (Yes in B608), the program proceeds to the aforementioned procedure (B605). If it is determined in B608 that no backup data of the NAND management information can be obtained from the HDD SA101 (No in B608), the activation preparation of the hybrid drive is not completed.

Thus, in the hybrid drive of the embodiment, when the NAND SA 111 is updated, the NAND management information stored in the NAND SA 111 is recorded in the HDD SA 101 beforehand defined in the HDD.

Therefore, even if the NAND management information cannot be obtained from the NAND SA 111 during the activation of the hybrid drive, it can be obtained from the HDD SA 101. This reduces the defectiveness occurrence ratio during activation of the hybrid drive to thereby enhance the reliability of the hybrid drive.

In the hybrid drive wherein the NAND memory 11 is used as a cache, the NAND management information is confirmed and updated highly frequently. Therefore, frequent acquisition of the NAND management information from the HDD leads to degradation of performance. In the embodiment, however, only when the NAND management information cannot be obtained from the NAND memory, it is obtained from the HDD, whereby there is little degradation of performance. Thus, the hybrid drive of the embodiment is a highly reliable storage device.

Further, a storage device, such as a hybrid drive, which comprises a large capacity nonvolatile memory (HDD) and a nonvolatile memory (NAND memory), can be realized as a highly reliable storage device without additional costs.

In addition, if the NAND management information cannot be read, the information indicating this may be recorded in the NAND memory 11 and/or in a part of the recording surface of the disk 21. The information indicating that the NAND management information cannot be read is, for example, information indicating the position of a defective area in the NAND memory 11.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a first nonvolatile storing unit having a pre-defined first management area; and
a second nonvolatile storing unit configured to process data at a higher rate than the first nonvolatile storing unit,
wherein the first nonvolatile storing unit stores, in the first management area, first management information associated with the first nonvolatile storing unit, and second management information associated with the second nonvolatile storing unit.

2. The storage device of claim 1, further comprising:
a first controller configured to cause the second management information to be stored in the first management area, and to read the second management information from the first management area; and
a second controller configured to cause the second management information to be stored in a second management area included in the second nonvolatile storing unit, and to read the second management information from the second management area.

3. The storage device of claim 2, wherein when the second controller cannot receive the second management information from the second management area, the first controller reads the second management information from the first management area.

4. The storage device of claim 2, wherein the second management information is stored redundantly in the second management area.

5. The storage device of claim 2, wherein whenever the second management information is updated, the second management information is stored in the first management area.

6. The storage device of claim 3, wherein the second management information is stored redundantly in the second management area.

7. The storage device of claim 3, wherein whenever the second management information is updated, the second management information is stored in the first management area.

8. The storage device of claim 4, wherein whenever the second management information is updated, the second management information is stored in the first management area.

9. A method of storing information of a storage device comprising a first nonvolatile storing unit having a pre-defined first management area, and a second nonvolatile storing unit configured to process data at a higher rate than the first nonvolatile storing unit, the method comprising:
storing, in the first management area, first management information associated with the first nonvolatile storing unit, and second management information associated with the second nonvolatile storing unit.

10. The method of claim 9, further comprising:
confirming whether the second management information can be read from a second management area included in the second nonvolatile storing unit; and
reading the second management information from the first management area when the second management information cannot be received from the second management area.

11. The method of claim 9, wherein the second management information is stored redundantly in the second management area.

12. The method of claim 9, wherein whenever the second management information is updated, the second management information is stored in the first management area.

13. The method of claim 10, wherein the second management information is stored redundantly in the second management area.

14. The method of claim 10, wherein whenever the second management information is updated, the second management information is stored in the first management area.

15. The method of claim 11, wherein whenever the second management information is updated, the second management information is stored in the first management area.
